(19) United States
(12) Patent Application Publication
(10) Pub. No.: US 2022/0368058 A1
(43) Pub. Date: Nov. 17, 2022

(54) METHOD, DEVICE AND SYSTEM FOR PRODUCING AN ELECTRIC CABLE

(71) Applicants: METZNER MASCHINENBAU GMBH, Neu-Ulm (DE); METZNER HOLDING GMBH, Ulm (DE)

(72) Inventor: Manfred Sorg, Ulm (DE)

(21) Appl. No.: 17/620,287

(22) PCT Filed: Jun. 22, 2020
(86) PCT No.: PCT/EP2020/067384

§ 371 Date: May 9, 2022

(30) Foreign Application Priority Data
Jun. 25, 2019 (DE) 10 2019 117 031.1
Jul. 22, 2019 (DE) 10 2019 119 723.6

(51) Int. Cl. H01R 13/46; H01B 7/36; H01R 43/28

(52) U.S. Cl. CPC H01R 13/465; H01B 7/368; H01R 43/28

(57) ABSTRACT

The invention relates to a method for producing an electric cable (2), according to which method the electric cable (2) is successively processed in independent processing modules (46, 47, 48). According to the invention, the electric cable (2), a sheath clamp (49) fixed on a cable sheath (18) of the cable (2), and/or a cable carrier (4) associated with the electric cable (2) during the processing thereof is rendered identifiable with an information carrier (9, 10), wherein documentation (13) of the processing of the electric cable (2) for at least one processing process of one of the processing modules (46, 47, 48) is created and associated with the electric cable (2).

### CROSS-REFERENCE TO RELATED APPLICATIONS

This US National Stage Non-Provisional Patent Application claims priority to earlier filed PCT Patent Application No. PCT/EP2020/067384 which was filed on 22 Jun. 2020 (and published as WO 2020/360216 A1 on 30 Dec. 2020), and also claims priority to earlier filed German Patent Application No. 10 2019 117 031.1 which was filed on 25 Jun. 2019, and still further claims priority to still earlier filed German Patent Application No. 10 2019 119 723.6 which was filed on 22 Jul. 2019. The entire contents of the aforementioned earlier filed PCT Patent Application and both of the aforementioned German Patent Applications is expressly and fully incorporated herein by this reference.

Pursuant to USPTO rules, this priority claim to earlier filed PCT Patent Application No. PCT/EP2020/067384 which was filed on 22 Jun. 2020, and to earlier filed German Patent Application No. 10 2019 117 031.1 which was filed on 25 Jun. 2019; and to still earlier filed German Patent Application No. 10 2019 119 7236 which was filed on 22 Jul. 2019 are all also included in the Application Data Sheet (ADS) filed herewith.

### TECHNICAL FIELD

The invention relates to a method for manufacturing an electric cable, according to which method the cable is processed in mutually independent processing modules in succession.

The invention further relates to a device for documenting the manufacture of an electric cable in the course of processing the cable in mutually independent processing modules.

The invention also relates to a computer program product and to a system for manufacturing an electric cable.

### BACKGROUND

When manufacturing cables, cable conductors are typically connected to a plug-in connector in order to be able to subsequently establish electrical connections with other cables or conductors which have corresponding plug-in connectors or mating plug-in connectors. A plug-in connector, or mating plug-in connector, may be, without limitation, a plug, a built-in plug, a socket, a coupling or an adapter. The term “plug-in connector” or “mating plug-in connector” used within the scope of the invention is representative of all variants.

Exacting requirements with respect to robustness and the security of the plug-in connections are imposed in particular on plug-in connectors for the automotive industry or for vehicles. Electromobility in particular poses challenges for the automotive industry and its suppliers since high currents with voltages of up to 1500 V are sometimes transmitted in the vehicles via the cables and/or lines. Due to the danger that would result from a failure of components in an electric vehicle, it is accordingly necessary for particularly exacting requirements to be imposed on the quality of the cables and/or lines and plug-in connections.

Accordingly, a plug-in connection has to withstand sometimes high loads, for example mechanical loads, and remain closed in a defined fashion, so that the electrical connection is not inadvertently severed, or otherwise disconnected, for example during operation of a vehicle.

For reasons of quality monitoring, and in order to make the cable manufacturing process as transparent as possible and comprehensible for the end customer, it may be advantageous to document the manufacture of the individual cables.

A further requirement made of plug-in connectors, in particular for the automotive industry, is that said plug-in connectors have to be able to be produced economically in large quantities. For this reason, as fully automated cable manufacture as possible is preferable, in particular for manufacturing cables for the automotive industry. Corresponding production lines therefore have to be established in order to achieve the required quantities with simultaneously high quality.

Documentation of the cable processing that can be traced back as far as individual cables is complex, in particular with regard to fully or partially automated cable manufacture.

In view of the known prior art, an object of the present invention is to provide an advantageous method for manufacturing an electric cable, in which method the cable processing can be documented in a comprehensible manner, in particular for an end consumer.

The present invention is also based on an object of providing an advantageous device for documenting the manufacture of an electric cable.

Finally, an object of the invention is also to provide an advantageous computer program product for carrying out a method for manufacturing an electric cable.

Furthermore, an object of the invention is to provide an advantageous system for manufacturing an electric cable, in which system the cable processing can be documented in a comprehensible manner, in particular for an end consumer.

The features described and disclosed herein relate to advantageous embodiments and variants of the invention.

A method for manufacturing an electric cable, according to which method the cable is processed in mutually independent processing modules in succession, is provided.

In particular, the invention may be provided for automated or fully automated manufacture of an electric cable.

The electric cable is preferably formed as a high-voltage line.

The method may be provided for manufacturing a single-core cable, which has a single inner conductor, and/or for manufacturing a multicore cable, which has a plurality of inner conductors.

That region of the electric cable in which the processing or the manufacture primarily takes place is sometimes also referred to herein as the “cable section to be processed”. The cable section to be processed may be a cable end piece. Preferably, two cable sections of the cable, in particular both cable end pieces, are processed, or manufactured with a respective plug-in connector.

The documentation described herein may relate primarily, or exclusively, to the processing of the cable sections to be processed, preferably one or both cable end pieces.

In principle, any desired electric cable with any desired plug-in connectors may be manufactured in the context of the invention. The electric cable preferably has an outer conductor or is formed as a shielded electric cable. The invention is particularly advantageously suitable for manufacturing electric cables with a large cross section for high power transmission, for example in the automotive sector, particularly preferably in the field of electromobility. It is thus possible for an electric cable for the high-voltage range to be provided, in particular a high-voltage line.

The multicore electric cable may have any desired number of inner conductors, for example two inner conductors or more inner conductors, three inner conductors or more inner conductors, four inner conductors or even more inner conductors. The inner conductors may run in a twisted fashion through the cable, in the manner of a twisted pair cable known from telecommunications or communications engineering. However, the inner conductors may also be routed in parallel in the cable.

The multicore electric cable is particularly preferably formed as a cable shielded with exactly one outer conductor and having exactly two inner conductors.

The single-core electric cable is preferably formed as a coaxial cable with exactly one inner conductor and exactly one outer conductor.

In the context of the invention, an inner conductor is understood to mean, in particular, a line running through the cable, which line is composed of an insulation and of an electrical conductor (core) running within the insulation. The electrical conductor, or the core, may be formed as a single wire or as a composite of multiple wires (also referred to as a stranded wire). In principle, however, the inner conductor mentioned in the context of the invention may also be composed exclusively of the electrical conductor or the core, or may also have yet further components in addition to the insulator.

Since, according to the invention, the cable manufacture is distributed across mutually independent processing modules, or processing processes, the method or the system to be described herein may be operated as an “assembly line process” or as a “cycle machine” with successive individual steps, in order to reduce the processing time for mass processing.

The Individual processing modules may further be of modular construction, as a result of which individual processing modules of the system can be replaced, modified or removed without a great deal of effort. In this way, the method can be configurable with simple means, in particular for processing different types of cable.

According to the invention, a cable having a cable sheath is provided, a sheath clamp is fastened to the cable sheath of the cable, and/or that a cable carrier assigned to the cable during the processing thereof are/is made identifiable by way of an information carrier. Documentation of the processing of the cable is compiled for at least one processing process of one of the processing modules and is assigned to the cable.

The sheath clamp may be fastened in a non-positively locking fashion at a defined axial position along the longitudinal axis of the cable.

In principle, any desired number of sheath clamps may be provided, for example one sheath clamp at each cable end, in order to be able to advantageously identify the cable at both cable ends. However, even more sheath clamps may be provided, which are distributed along the longitudinal axis of the cable on the cable sheath. The sheath clamps may also serve to block, in a positively locking fashion, the displacement path of plug-in connector components that have been attached to the cable sheath of the cable.

The sheath clamp may preferably be a clamp for holding objects together in a non-positively locking fashion.

The sheath clamp may have a clamping region for fastening to the cable sheath. The clamping region may have, for example, two or more clamping jaws, for example clamping jaws composed of a plastic, or for example, only and without limitation, rubber. The clamping region may optionally also have one or more claws in order to further strengthen the fastening to the cable sheath. However, the use of claws is not preferred owing to the associated adverse effect on the cable sheath.

The sheath clamp may furthermore have an actuation region. The actuation region may be actuated, in particular, by a user or by a device for handling and/or fastening the sheath clamp. In particular, the actuation region may serve to at least partially open the sheath clamp—preferably counter to a spring force for closing the sheath clamp—for the purposes of fastening to the cable sheath of the cable.

The sheath clamp may preferably have two clamping limbs which are connected to one another in a central section, wherein the first ends of the clamping limbs form the actuation region and the second ends of the clamping limbs form the clamping region. A spring may be arranged at the connection region of the two clamping limbs, which spring presses the two clamping limbs together by way of their respective second ends.

In principle, the sheath clamp may have any desired structure. The sheath clamp may, for example, also have one or more elastic fastening rings or be composed of one or more elastic fastening rings. For example, an elastic fastening ring may be formed from a plastic, preferably rubber (in the manner of a rubber seal), in order to be clamped in a non-positively locking fashion on the cable sheath. Resilient, part-ring-shaped fastening rings, for example composed of a metal, may also be provided.

Furthermore, the sheath clamp may also be of magnetic form, for example. For this purpose, the sheath clamp may have, for example, two half-shells that are magnetically connectable to one another.

Provision may be made for the at least one sheath clamp to be removed from the cable sheath of the cable again after the processing by at least one of the processing modules, preferably after the processing by all of the processing modules.

In principle, however, provision may also be made for at least one of the sheath clamps not to be removed and to be delivered, for example, together with the manufactured electric cable.

The at least one sheath clamp is preferably assigned to the cable throughout the entire manufacturing process.

The cable carrier may be part of a workpiece carrier system. The cable carrier may transport the cable between the individual processing modules along the production line by means of a workpiece conveyor (for example a transporting belt/conveyor belt). However, instead of a workpiece conveyor, the cable carrier may also be transported between the individual processing modules by a production technician, for example with the aid of a roller track. Provision may also be made for the cable carrier to be transported between individual processing modules by means of a gripper.

In principle, a plurality of cable carriers which are each assigned to different processing modules may also be provided. For example, a first cable carrier may transport the cable between processing modules of a first group of processing modules and a second cable carrier may transport the cable between processing modules of a second group of processing modules. Even more cable carriers and assigned processing modules may also be provided, wherein it is even possible for one cable carrier to be provided for each processing module. The cable may be transferred between the individual cable carriers, for example, by means of a gripper device or any other transportation device, preferably with a known or unchanged alignment or orientation.

The cable carrier may have one or a plurality of fixing means in order to axially and/or radially fix the cable. At least one of the two cable ends is preferably fixed on the cable carrier. The cable or the cable end is preferably fixed on the cable carrier in such a way that said cable or cable end may be processed directly by the processing modules once the cable carrier has fed the cable or the cable end to the module. Provision may optionally be made for the cable carrier, a feeding device or a production technician to introduce the cable end to be processed into the processing module, in particular orthogonally to the conveying direction of the workpiece conveyor.

Depending on the overall length of the cable, provision may be made for both cable ends to be fixed on the cable carrier, wherein the cable may preferably be fastened to the cable carrier in such a way that the cable, between its cable ends, forms a U-shaped or helically wound profile.

The cable carrier is preferably assigned to the cable throughout the manufacturing process. However, provision may also be made for the cable carrier to be assigned to the cable only during part of the manufacturing process and for the cable, after processing by a first group of processing modules, to first be passed on to a further cable carrier or assigned to another cable carrier for further manufacture or for processing by a second group of processing modules.

The documentation of the processing of the cable is preferably assigned taking into consideration information imprinted onto or into the information carrier.

Since the documentation of the processing of the cable is assigned to the cable by means of the information carrier, the method according to the invention is particularly advantageously suitable for use in the course of automated or fully automated manufacture of the electric cable.

In an advantageous development of the invention, provision may be made for a unique identifier for the cable to be imprinted into the information carrier.

The cable can thus be clearly identifiable on the basis of the identifier in the course of the cable manufacturing process—and preferably also later.

According to a development of the invention, provision may be made for a unique identifier imprinted on the information carrier to be assigned to the cable temporarily for the manufacture of said cable.

In particular if the information carrier already has an identifier, the need for imprinting an identifier may optionally be dispensed with. The existing identifier, for example a consecutive master number of cable carriers or sheath clamps, can thus be used in order to uniquely identify the cable (at least in the course of the cable manufacturing process). A serial number already printed on the cable, for example, or a similar identifier may also be suitable as a unique identifier in the course of this method.

According to a development of the invention, provision may be made for the documentation to be at least partially imprinted into the information carrier.

If the information carrier is suitable for storing supplementary data, the documentation may advantageously already be imprinted (in full or in part) into or onto the information carrier. This may optionally eliminate the need for a separate database or a separate data memory.

In a particularly preferred development of the invention, provision may be made for a global database to be used, in which documentation compiled in the course of the cable manufacturing process is assigned to individual cables, preferably on the basis of the unique identifier.

Owing to the use of a global database, the possible flexibility in the storage and assignment of the documentation is particularly advantageous. The information carrier, in particular an identifier contained in the information carrier, may be usable in the database as a designation of the dataset which has the documentation of a specific cable.

In a development of the invention, provision may be made for the cable, the sheath clamp and/or the cable carrier to be made identifiable by applying and/or modifying the information carrier.

Provision may thus be made for the information carrier (and optionally the identifier) to be applied to the cable, the sheath clamp and/or the cable carrier for the first time in the course of the method, for example at the beginning of the electric cable manufacturing process. The information carrier may be, for example, printed or adhesively bonded on, for example in the manner of a label in the course of a labeling process.

An existing information carrier may however optionally also be modified in order to make the cable or the sheath clamp or the cable carrier identifiable. For example, information may be added to the information carrier or information on the information carrier may be revised.

In an advantageous development of the invention, provision may be made for the information carrier to be of optical and/or electronic form.

An information carrier of optical or electronic form has proven to be particularly suitable. In principle, however, it is also possible in the context of the invention for a magnetic, haptic and/or some other information carrier to be provided.

In a development of the invention, provision may be made for the optical information carrier to be formed as a barcode, numerical code and/or 2D code, for example a data matrix code or QR code.

The codes mentioned have proven to be particularly suitable for forming an optical information carrier.

It may be advantageous to equip the information carrier with an error correction method, for example to provide redundant information. In particular, an optical information carrier may sometimes be susceptible to errors during the reading-out of the information.

An optical information carrier may be highly suitable in particular for direct identification of the cable, for example if the information carrier is applied directly to the cable.

The information carrier (and optionally the identifier) may also be applied to the same cable multiple times. In particular, provision may be made to apply and/or modify an information carrier at both cable ends.

In an advantageous development of the invention, provision may be made for the electronic information carrier to comprise at least one programmable memory module, for example an RFID transponder, which is modified or configured/programmed to identify the cable and/or to document the processing of the cable.

In the context of the invention, an electronic information carrier, for example an RFID transponder, may particularly advantageously be used, for example, also to store the documentation or at least parts of the documentation electronically and to link said documentation or parts of the documentation directly to the cable, the sheath clamp and/or the cable carrier.

An electronic information carrier, in particular an RFID transponder, may be particularly highly suitable for indirect identification of the cable by way of the sheath clamp fastened to the cable sheath or the cable carrier assigned to the cable, if the information carrier is applied to the sheath clamp or to the cable carrier.

In an advantageous development of the invention, provision may be made for the documentation to be used in the context of quality management.

Quality assurance or quality control to ensure the defined quality requirements is particularly relevant in particular in the context of the manufacture of an electric cable for the automotive industry. The documentation according to the invention may be particularly advantageous for this purpose.

In an advantageous development of the invention, provision may be made for the cable to be sorted or reprocessed in a manner dependent on the information contained in the documentation.

For example, provision may be made for the cable to be sorted into different quality classes in a manner dependent on the information contained in the documentation. Provision may also be made for the cable to be sorted out and removed from the production chain in a manner dependent on the information contained in the documentation.

In a development of the invention, provision may be made for information relating to a successful processing process, an incorrect processing process, a failed processing process and/or at least one process parameter of the processing process to be recorded in the documentation.

For example, the successful processing, incorrect processing, failed processing and/or at least one process parameter may be recorded in the documentation for each of the mutually independent processing processes or for each of the mutually independent processing modules.

The process parameter may be, for example, a parameter that particularly characterizes the processing process. The process parameter may be, for example, a force, a moment and/or a pressure. For example, the intended pressing force, and/or actual pressing force detected by measurement, of a crimping process may be recorded in the documentation.

If failed and/or incorrect processing has been documented, provision may be made to terminate the cable manufacturing process for the corresponding cable. A subsequent processing module may, for example, read out the documentation of the cable to be processed prior to the commencement of the cable processing operation and check whether the cable is approved for processing. The cable may optionally be transferred onward by the individual processing modules in each case without being processed, until said cable has left the production line.

According to a development of the invention, provision may be made for the documentation to include information relating to waste and/or particle monitoring and/or a check for an absence of damage to a cable component of the cable and/or a check for an absence of damage to a plug-in connector component of a plug-in connector that is to be fitted on the cable and/or a check of a radial alignment of the plug-in connector component and/or a check of an axial position of the plug-in connector component and/or a check for the presence of certain plug-in connector components after a fitting process and/or a check of a diameter of a cable section of the cable and/or a check for protruding individual wires and/or a check for sufficient fastening, for example latching, of the plug-in connector component and/or a check of electrical properties of the partially fitted or fully fitted plug-in connector.

It is very particularly preferred if the documentation includes information relating to a check of an axial position of the plug-in connector component, for example of the spacing between the front end of a contact element attached to an inner conductor of the cable and a support sleeve.

Furthermore, it is particularly preferred if the documentation includes information relating to the check of a diameter of a cable section of the cable, in particular of the diameter of a section onto which a plug connector component is to be pushed in a subsequent processing process. For example, the diameter of a fabric tape that has been applied to a cable shielding braid folded back over the cable sheath may be detected by measurement, and the result of the measurement may be recorded in the documentation.

In addition, it is particularly preferred if the documentation includes information relating to the check for protruding individual wires or stranded wires, for example of a cable shielding braid.

In an advantageous development of the invention, provision may be made for the information for the documentation to be detected by a control unit using a communication interface and/or a sensor device.

That information of the individual processing processes which is relevant for the documentation may be read out, for example, by a controller of a respective processing module (for example specified process parameters and/or process parameters actually detected by measurement during the processing). The respective processing modules may have dedicated sensors in order to detect the relevant information.

In particular for checking of the processing processes performed on the cable in the context of quality management, it is also possible for a separately formed sensor device to be provided which is communicatively connected to the control unit and which transmits results of the check, for example of the checks listed above, to the control unit for compiling the documentation.

In an advantageous development of the invention, provision may be made for an optical sensor device, preferably with at least one optical sensor, to be used in order to detect information for the documentation in the context of optical quality monitoring of the cable.

The at least one optical sensor is preferably formed as a camera in order to capture at least one individual image or a video sequence which may subsequently be evaluated by the control unit.

The line of sight of the at least one optical sensor may preferably be aligned with the cable or with the cable end to be processed, wherein transmitted light or back light, incident light and/or grazing light or side light can be generated for detecting the information or the state of the cable starting from a lighting unit.

A first optical sensor is preferably provided, the line of sight of which is aligned with the cable end, wherein a first lighting unit is arranged behind the cable end along the line of sight of the first sensor in order to generate transmitted light for detecting the state of the cable end.

Furthermore, a second optical sensor may preferably be provided, the line of sight of which is aligned with the cable end, wherein a second lighting unit is arranged in front of the cable end along the line of sight of the second sensor in order to generate incident light for detecting the state of the cable end.

The second optical sensor may be arranged so as to be offset with respect to the first optical sensor by a defined angle, preferably arranged so as to be offset by 45° to 135°, and very particularly preferably arranged so as to be offset by approximately 90° or exactly 90.

According to one development of the invention, provision may be made for the at least one optical sensor to be rotated radially around a central axis of the cable and/or for the cable to be rotated about the central axis while the at least one sensor detects the information.

Particularly exact detection of the processing state of the corresponding cable end is possible in this way.

In particular, provision may be made for the lighting unit assigned to a sensor to be rotated synchronously with the sensor.

The optical quality monitoring described may comprise, in particular, a check for the presence of certain plug-in connector components of a plug-in connector to be fitted on the cable end (fitting check), a check for individual wires protruding from the cable end, a check of an axial position of a plug-in connector component of a plug-in connector to be fitted on the cable end and/or a check of a diameter of a cable section adjoining the cable end.

In the context of the optical quality monitoring described, the state of the cable end may preferably be detected following a cleaning process for removing particles adhering to the cable end, in order to improve the accuracy of the optical quality monitoring. The cleaning process may also be called a processing process in the context of the invention.

Particles may include, inter alia, metallic particles, non-metallic particles, fibers (in particular plastics fibers), pieces of foil or film (of a metallic foil, of a non-metallic film or of a composite foil/film) and dust particles. A powdered mineral, for example talc, may also be regarded as particles in the context of the invention. In particular, particles or fibers composed of metal chips, resins, plastics, minerals or dust may advantageously be removed.

Therefore, the technical cleanliness may advantageously be established in the course of the manufacture of the electric cable, in particular in the course of automated or fully automated manufacture of an electric cable, by way of a corresponding cleaning process being executed, for example, after the cable is cut to length and/or stripped of insulation.

The removal of the particles may advantageously be provided, in particular, before the application of plug-in connector components in the context of the system for manufacturing the cable still to be described herein.

The invention also relates to a device for documenting the manufacture of an electric cable in the course of the processing of the cable in mutually independent processing modules.

The electric cable may be formed, for example, as a high-voltage line.

The device is preferably designed for automated or fully automated cable manufacture.

In the context of the device according to the invention, provision is made for the cable, a sheath clamp fastened to a cable sheath of the cable, and/or a cable carrier assigned to the cable during the processing thereof to have an information carrier for identification purposes, and wherein documentation of the processing of the cable for at least one processing process of one of the processing modules is assigned to the cable by means of the information carrier.

Provision may be made for the method described herein to be carried out using said device.

A control unit may be provided for the assignment of the documentation.

The invention also relates to a computer program product with program code means in order to carry out a method according to the statements herein when the program is executed on a control unit of a device for documenting the manufacture of an electric cable.

The control unit may be designed as a microprocessor. Instead of a microprocessor, any other device for implementing the control unit may also be provided, for example one or more arrangements of discrete electrical components on a printed circuit board, a programmable logic controller (PLC), an application-specific integrated circuit (ASIC) or some other programmable circuit, for example also a field programmable gate array (FPGA), a programmable logic arrangement (PLA) and/or a commercially available computer.

The invention also relates to a system for manufacturing an electric cable, in particular a high-voltage line. The system comprises a device for documenting the manufacture of the electric cable, according to the statements herein. The system further comprises at least two mutually independent processing modules for manufacturing the electric cable.

The distribution according to the invention of the processing steps across multiple mutually independent modules makes it possible to operate the system as an “assembly line process” or as a “cycle machine” with successive individual steps, in order to reduce the processing time for mass processing.

The device, or the individual processing modules, may further be of modular construction, as a result of which individual processing modules of the assembly can be replaced, modified or removed without a great deal of effort. In this way, the system can be configurable with simple means, in particular for processing different types of cable.

The independent processing modules may preferably be arranged upstream of or downstream of the device.

In an advantageous development of the invention, provision may be made for at least one of the processing modules to be formed as a processing module for stripping insulation from a portion of a cable component of the cable and/or as a processing module for fitting the electric cable with a plug-in connector component of a plug-in connector to be fitted on the electric cable, and/or to be formed as a processing module for fitting a plug-in connector component of an electrical plug-in connector, in particular a contact element or a contact parts carrier, and/or to be formed as a processing module for ensuring correct fitting of the contact parts carrier, and/or to be formed as a processing module for cleaning the cable to remove particles adhering to the cable.

Yet further processing modules which are independent of one another and of the device and are arranged upstream or downstream of the device may also be provided.

The invention also relates to an electric cable that has been processed in line with a method according to the statements herein.

In addition, the invention relates to an electric cable that has been processed using a system according to the statements herein.

Features that have been described in conjunction with the method according to the invention can self-evidently also be advantageously implemented for the device, the computer program product and the system—and vice versa. Furthermore, advantages that have already been mentioned in conjunction with the method according to the invention can also be understood as relating to the device, the computer program product or the system—and vice versa.

In addition, it should be noted that expressions such as “comprising”, “having” or “with” do not exclude any other features or steps. Furthermore, expressions such as “a” or “the” that refer in the singular to steps or features do not exclude multiple features or steps—and vice versa.

It is furthermore emphasized that the values and parameters described herein also encompass deviations or fluctuations of ±10% or less, preferably ±5% or less, more preferably ±1% or less, and very particularly preferably ±0.1% or less, of the respectively stated value or parameter, if such deviations are not ruled out in practice in the implementation of the invention. The specification of ranges by way of start and end values also encompasses all values and fractions encompassed by the respectively stated range, in particular the start and end values and a respective mean value.

Exemplary embodiments of the invention will be described in more detail with reference to the accompanying Figures.

The figures each show preferred exemplary embodiments in which individual features of the present invention are illustrated in combination with one another. Features of one exemplary embodiment may also be implemented separately from the other features of the same exemplary embodiment, and may accordingly be readily combined by an expert to form further useful combinations and sub-combinations with features of other exemplary embodiments.

### SUMMARY

Our method, device and system for producing an electrical cable generally provides a method for producing an electric cable (2), according to which method the cable (2) is processed in mutually independent processing modules (46, 47, 48) in succession, characterized in that the cable (2), sheath clamp (49) fastened to a cable sheath (18) of the cable (2), and/or a cable carrier (4) assigned to the cable (2) during the processing thereof are/is made identifiable by way of an information carrier (9, 10), wherein documentation (13) of the processing of the cable (2) is compiled for at least one processing process of one of the processing modules (46, 47, 48) and is assigned to the cable (2).

A principal aspect of the present invention is a method characterized in that a unique identifier (14) for the cable (2) is imprinted it the information carrier (9, 10).

A further aspect of the present invention is a method characterized in that a unique identifier (14) imprinted onto the information carrier (9, 10) is temporarily assigned to the cable (2) for manufacturing said cable.

A further aspect of the present invention is a method characterized in that the documentation (13) is at least partially imprinted into the information carrier (9, 10).

A further aspect of the present invention is a method characterized in that a global database (15) is used, in which documentation (13) compiled in the course of the cable manufacturing process is assigned to individual cables (2), preferably on the basis of the unique identifier (14).

A further aspect of the present invention is a method characterized in that the cable (2), the sheath clamp (49) and/or the cable carrier (4) are/is made identifiable by applying and/or modifying the information carrier (9, 10).

A further aspect of the present invention is a method characterized in that the information carrier (9, 10) is of optical and/or electronic form.

A further aspect of the present invention is a method characterized in that the optical information carrier (9) is formed as a barcode, numerical code and/or 2D code, for example a data matrix code or QR code.

A further aspect of the present invention is a method characterized in that the electronic information carrier (10) comprises at least one programmable memory module, for example an RFID transponder, which is modified to identify the cable (2) and/or to document the processing of the cable (2).

A further aspect of the present invention is a method characterized in that the documentation (13) is used in the context of quality management.

A further aspect of the present invention is a method characterized in that the cable (2) is sorted or reprocessed in a manner dependent on the information contained in the documentation (3).

A further aspect of the present invention is a method characterized in that information relating to a successful processing process, an incorrect processing process, failed processing process and/or at least one process parameter of the processing process is recorded in the documentation (13).

A further aspect of the present invention is a method characterized in that the documentation (13) includes information relating to: waste and/or particle monitoring and/or; a check for an absence of damage to a cable component of the cable (2) and/or; a check for an absence of damage to a plug-in connector component (27, 28, 29, 30, 31, 33) of a plug-in connector (24) that is to be flite on the cable (2) and/or; a check of a radial alignment of the plug-in connector component (27, 28, 29, 30, 31, 33) and/or; a check of an axial position of the plug-in connector component (27, 28, 29, 30, 31, 33) and/or; a check for the presence of certain plug-in connector components (27, 28, 29, 30, 31, 31) after a fitting process and/or; a check of a diameter (D) of a cable section of the cable (2) and/or a check for protruding individual wires (32) and/or; a check for sufficient fastening, for example latching, of the plug-in connector component (27, 28, 29, 30, 31, 33) and/or; a check of electrical properties of the partially fitted or fully fitted plug-in connector (24).

A further aspect of the present invention is a method characterized in that the information for the documentation (13) is detected by a control unit (16) using a communication interface and/or a sensor deice (39).

A further aspect of the present invention is a method characterized in that an optical sensor device (39), preferably with at least one optical sensor (40, 42), is used in order to detect information for the documentation (13) in the context of optical quality monitoring of the cable (2).

A further aspect of the present invention is a method characterized in that the at least one optical sensor (40, 42) is rotated radially around a central axis (M) of the cable (2), and/or in that the cable (2) is rotated around the central axis (M) while the at least one sensor (40, 42) detects the information.

A further aspect of the present invention is a device (1) for documenting the production of an electric cable (2) in the course of the processing of the cable (2) In mutually independent processing modules (46, 47, 48), characterized in that the cable (2), a sheath clamp (49) fastened to a cable shah (18) of the cable (2), and/or a cable carrier (4) assigned to the cable (2) during the processing thereof have/has an information carrier (9, 10) for identification purposes, and wherein documentation (13) of the processing of the cable (2) for at least one processing process of one of the processing modules (46, 47, 48) is assigned to the cable (2) by means of the information carrier (9, 10).

A further aspect of the present invention is a computer program product with program code means in order to carry out a method when the grogram is executed on a control unit (16) of a device (1) for documenting the production of an electric cable (2).

A further aspect of the present invention is a system (26) for producing an electric cable (2), comprising a device (1) for the documentation of the production of the electric cable (2) as claimed in claim 17; and at least two mutually independent processing modules (46, 47, 48) for producing the electric cable (2).

A further aspect of the present invention is a system (26) characterized in that at least one of the processing modules is formed as a processing module for stripping insulation from a portion of a cable component of the cable (2) and/or processing module for fitting the electric cable (2) with a plug-in connector component (27, 28, 29, 30, 31, 33) of a plug-in connector (24) to be fitted on the electric cable (2), and/or is formed as a processing module (47, 48) for fitting a plug-in connector component (27, 28, 29, 30, 31, 33) of an electrical plug-in connector (24), in particular an internal conductor contact element (23) or a contact parts carrier (33), and/or is formed as a processing module for ensuring correct fitting of the contact parts carrier (33), and/or is formed as a processing module for cleaning the cable (2) to remove particles adhering to the cable (2).

These and other aspects of the present invention are more fully set forth herein.

### BRIEF DESCRIPTIONS OF THE FIGURES

Elements of identical function are denoted by the same reference signs in the figures.

FIG. 1 is a plan view of an electric cable fastened to a cable carrier, two exemplary information carriers and a control unit and a global database for assigning documentation according to the invention.

FIG. 2 is an orthographic side view of an exemplary two-core electric cable fitted with four plug-in connector components.

FIG. 3 is an orthographic side view of an exemplary single-core electric cable fitted with three plug-in connector components.

FIG. 4 is an orthographic side view of a partially preassembled two-core electric cable.

FIG. 5 is a plan view of a device for fitting a contact parts carrier to two contact elements of the two-core cable during detection of an actual axial position of the contact elements within the contact parts carrier by means of different, exemplary sensors.

FIG. 6 shows an optical sensor device with two optical sensors and two lighting units for optical quality monitoring of the cable processing operation in the course of the documentation according to the invention.

FIG. 7 is a plan a system for producing an electric cable with a device for documenting the production of the electric cable and at least two mutually independent processing modules.

### DETAILED WRITTEN DESCRIPTION OF THE PREFERRED EMBODIMENTS

This disclosure of the invention is submitted in furtherance of the Constitutional purposes of the US Patent Laws “to promote the progress of Science and the useful arts” (Article 1, Section 8).

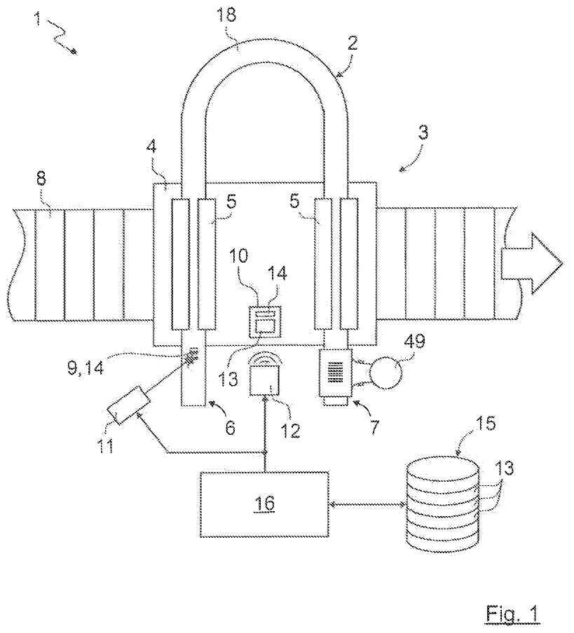

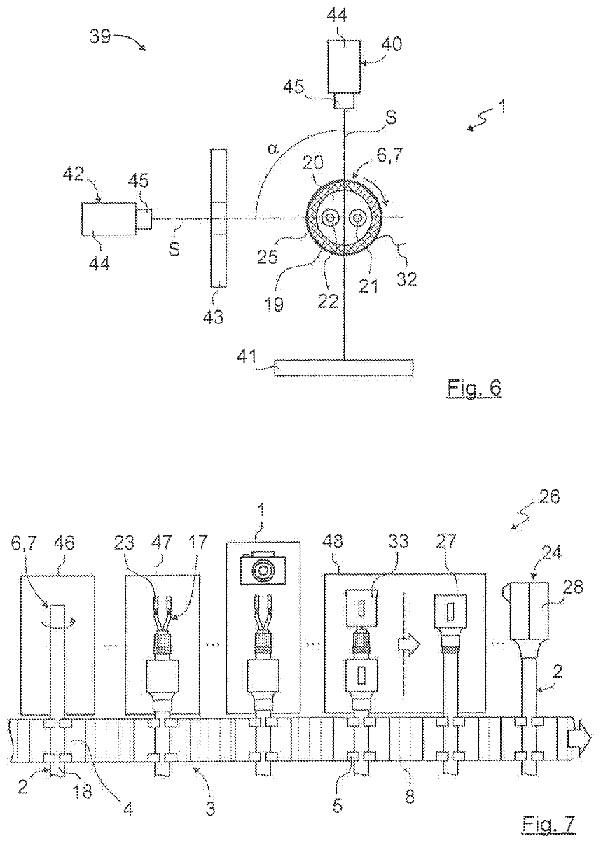

FIG. 1 shows a device 1 for documenting the manufacture of an electric cable 2 in the course of processing the cable 2 in mutually independent processing modules (cf. FIG. 7).

A workpiece carrier system 3 is provided, which has a cable carrier 4 to which the electric cable 2 is fastened. The electric cable 2 can therefore be assigned to the cable carrier 4 as it is being processed throughout the manufacturing process or during part of the manufacturing process.

The cable carrier 4 has clamping jaws 5 in order to fix the first cable end 6 and/or the second cable end 7 of the cable 2, in the exemplary embodiment both cable ends 6, 7. In the exemplary embodiment, the cable 2 is clamped into the cable carrier 4 in such a way that a U-shaped profile is formed between the two cable ends 6, 7. In principle, a profile deviating from this may also be provided, for example a helical winding in the case of a relatively long cable 2. Provision may also be made for only one of the two cable ends 6, 7 to be received in the cable carrier 4. The actual configuration of the cable carrier 4 and the manner of fastening of the cable 2 on the cable carrier 4 are not of importance in the context of the invention.

In order to transport the cable 2 between the independent processing modules for processing said cable 2, the cable carrier 4 is fitted, by way of example, on a transportation device in the form of a conveyor belt 8. In principle, however, the cable 2 may be moved between the processing modules in any desired manner, for example only, and without limitation, including by a production technician using a roller track.

Provision is made for the cable 2 and/or the cable carrier 4 to have an information carrier 9, 10 for identification purposes. By way of example, an optical information carrier 9 is illustrated on the first cable end 6, and an electronic information carrier 10 is illustrated on the cable carrier 4. In principle, it may already be sufficient in the context of the invention for either the cable 2 or the cable carrier 4 to have an information carrier 9, 10. A plurality of information carriers 9, 10 may also be provided, in particular one information carrier 9, 10 on each of the two cable ends 6, 7 of the cable 2.

The optical information carrier 9 is illustrated, by way of example, as a barcode. However, the optical information carrier 9 may also be, for example only, and without limitation, a numerical code and/or 2D code, for example a data matrix code or a QR code.

In the context of the invention, the information carrier 9, 10 may be applied to the cable 2 and/or to the cable carrier 4, for example only, and without limitation, by means of the laser 11 illustrated. Provision may also be made to modify an existing information carrier 9, 10, for example a serial number already printed on the cable 2 or an existing barcode. Instead of a laser 11, any desired device for applying and/or modifying an optical information carrier 9, for example only, and without imitation, even an inkjet printer, may be provided in principle.

The electronic information carrier 10 may be, for example only, and without limitation, at least one programmable memory module, in particular an RFID transponder, which can be modified to identify the cable 2 and/or to document the processing of the cable 2. For example, a read/write device 12 for communicating with the RFID transponder is illustrated in FIG. 1.

As an alternative to, or in addition to an information carrier 9, 10 on the cable 2 or on the cable carrier 4, provision may also be made for the cable 2 to be made identifiable by means of at least one sheath clamp 49 fastened to the cable sheath 18. An exemplary sheath clamp 49 is fastened to the second cable end 7 of the cable 2 in FIG. 1. The sheath clamp 49 may likewise be provided with any desired information carrier 9, 10. A barcode is illustrated by way of example.

In principle, different types of sheath clamps 49 may be provided. For example, the clamp illustrated in FIG. 1, which has an actuation region and a fastening region, may be provided. By means of the actuation region, the clamping jaws which are situated at the opposite end of two clamping limbs and which form the fastening region can be opened counter to the spring force of a resetting spring, and the sheath clamp 49 can thus be attached radially to the cable 2. As an alternative, however, sheath clamps with lashing elements in the form of a cable tie may also be provided. A sheath clamp with a metallic partial ring that can be clamped may also be provided. Furthermore, a sheath clamp may have an elastic ring, for example a rubber ring, similar to a sealing ring. Magnetic sheath clamps may also be provided. The exact configuration of the sheath clamp 49 is not of absolute importance in the context of the invention. The at least one sheath clamp 49 is preferably fastened in a non-positively locking and reversible fashion to the cable sheath 18 of the cable 2.

In principle, all the features that are described in respect of an information carrier 9, 10 applied to the cable 2 or to the cable carrier 4 may also be suitable for use with an information carrier 9, 10 applied to the sheath clamp 49, and for this reason the sheath clamp 49 is not discussed in further detail herein.

According to the invention, provision is further made for documentation 13 of the processing of the cable 2 to be compiled for at least one processing process of one of the processing modules and to be assigned to the cable 2.

For this purpose, for example, a unique identifier 14 for the cable 2 may be imprinted into or onto the information carrier 9, 10 and/or a unique identifier 14 that has already been imprinted on, or in, the information carrier 9, 10 is temporarily assigned to the cable 2 for producing said electric cable 2.

The identifier 14 may be, for example only, and without limitation, a binary, decimal or hexadecimal numerical value or a numerical sequence. The identifier 14 may be encoded or imprinted, for example, in the barcode or some other code. The identifier 14 may also be imprinted or stored or saved in an electronic component, for example only, and without limitation a memory module, for example in the RFID transponder 10.

For example, provision may also be made for different cable carriers 4 to already have a respective information carrier 9, 10 with a respectively unique identifier 14. Owing to the assignment of the cable 2 to the cable carrier 4 during the manufacture or at least during a sub-process of the manufacture, the documentation 13 can ultimately be assigned according to the invention. However, provision may also be made, for example, for the information carrier 9, 10 to be provided in targeted fashion with an identifier 14 for the identification of the cable 2 for the manufacturing process to be documented.

Provision may be made for the documentation 13 to be at least partially imprinted into and/or onto the information carrier 9, 10. This may be advantageous in particular when the information carrier 9, 10 is an electronic information carrier 10 on which sufficient storage space is available (indicated in FIG. 1). However, provision is also made, for example, for a continuous numerical sequence or a similar code to be provided in order to record the documentation 13 continuously in the course of the cable manufacture, for example in optical form on the cable 2.

For example, one, some, or all of the processing modules may have a read/write unit 12 and/or a scanner for reading out a barcode (or some other code) and/or a laser 11 or a printer in order to augment the documentation 13 or to evaluate said documentation for the cable processing operation.

However, a global database 15 may preferably be used, in which documentation 13 compiled in the course of the manufacture production line may be assigned to individual cables 2, preferably on the basis of the respective unique identifier 14. The addressing in the database 15 may thus be implemented in a manner dependent on the identifier 14 of the respective cable 2.

A control unit 16 may be provided in the context of the device 1 according to the invention for documenting the manufacture in order to carry out the described method. The control unit 16 may be communicatively/operatively connected, for example, to the devices for imprinting and/or reading out and/or modifying the information carrier 9,10 (indicated with regard to the laser 11 and the read/write unit 12) and may furthermore be communicatively/operatively connected to the database 15.

For example, information relating to a successful processing process, an incorrect processing process, a failed processing process and/or at least one process parameter of the processing process may be recorded in the documentation 13. The documentation 13 may be used in the context of quality management. In the context of the quality management, provision may for example be made to sort the cable 2 or to approve it for post-processing in a manner dependent on the information contained in the documentation 13. In particular, removal of an incorrectly processed cable 2 in the course of the cable manufacture may be provided in the context of quality management.

The information for the documentation 13 may be recorded by the control unit 16 using a communication interface, for example. For example, the control unit 16 may be communicatively connected to the individual processing modules via a respective communication interface in order to obtain information relating to the processing processes from the respective processing modules and record said information in the documentation 13.

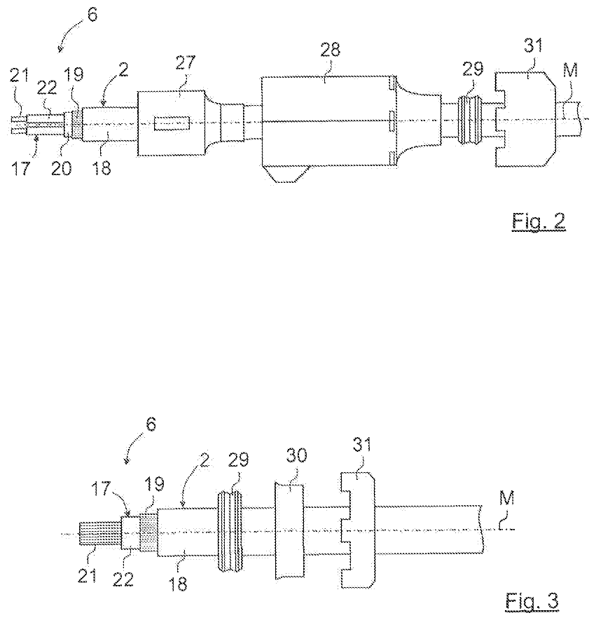

FIG. 2 illustrates an enlarged side view of an exemplary multicore electric cable 2.

As illustrated in FIG. 2, inner conductors 17 of the cable 2 extend from the first cable end 6 to the second cable end 7 (cf. FIG. 4 as well). The multicore electric cable 2 has already been partially processed at its first cable end 6.

The two-core cable 2 illustrated has a cable sheath 18 and a cable shielding braid 19 running underneath the cable sheath 18. A shielding foil or film may optionally run above the cable shielding braid 19 (not illustrated). The two inner conductors 17 run within a filler layer 20 below the cable shielding braid 19. The electrical conductors 21 or cores of the two inner conductors 17 are each encased by an insulation 22. In the course of the cable manufacture, the inner conductors 17 may be exposed in the region of their inner conductor ends, as illustrated. Inner conductor contact elements 23 (cf. FIG. 4 for example) of an electrical plug-in connector 24 (cf. FIG. 7) may then be fastened, in particular crimped, to the respective inner conductor ends. In the course of the cable manufacture, the cable shielding braid 19 may be folded back over the cable sheath 18, preferably over a metal sleeve or supporting sleeve, not illustrated, and optionally fixed to a fabric tape 25 (cf. FIG. 4).

The two-core cable 2 illustrated in FIG. 2 is to be understood merely by way of example for use with the invention. In principle, the invention is suitable for use with any desired type of cable, for example also including for use with an electric cable 2 having just one inner conductor 17, for example of coaxial design, as illustrated in FIG. 3.

FIG. 3 shows the front, free end or the first cable end 6 of a single-core electric cable 2 that has already been partially stripped of insulation. The single-core cable 2 likewise has a cable sheath 18 and a cable shielding braid 19 running underneath the cable sheath 18. The cable shielding braid 19 may likewise be folded over onto a supporting sleeve, not illustrated. The insulation 22 or the primary insulation of the inner conductor 17 runs underneath the cable shielding braid 19. The inner conductor 17 may be formed, for example, as a stranded wire comprising several individual wires, as indicated in FIG. 3. In principle, however, the exact structure of the single-core cable 2 is not of importance.

It should be emphasized at this point that features and advantages of the method, the system 26 (cf. FIG. 7) described herein below and/or the device 1 which relate to the manufacture of the two-core or multicore electric cable 2 may also be transferred to the manufacture of the single-core electric cable 2—and vice versa (provided that this is not technically ruled out).

In the course of the manufacture of the electric cable 2, provision may be made to fit the cable sheath 18 of the cable 2 with two or more plug-in connector components for plug-in connector fitting starting from the front, free end of the cable 2. These plug-in connector components may be, for example only, and without limitation, a shielding sleeve 27 (cf. FIG. 2), a plug-in connector housing 28 (cf. FIG. 2), a line seal 29 (cf. FIG. 2 or FIG. 3), a cable retainer 30 (cf. FIG. 3), a retaining cap 31 or closure cap (cf. FIG. 2 or FIG. 3) or an angle cap. In principle, the configuration of the plug-in connector component 27, 28, 29, 30, 31 to be pushed onto the cable sheath 18 of the cable 2 is not of importance in the context of the invention. In principle, the single-core or the multicore electric cable 2 may be provided with any desired plug-in connector components in the course of the cable manufacture.

In the course of the manufacture of a two-core or multicore electric cable 2, it may however be the case in particular that fitting in accordance with the sequence, illustrated in FIG. 2, of a shielding sleeve 27, followed by a socket housing or a plug-in connector housing 28, followed by a line seal 29, followed by a retaining cap 31 (or an angle cap in the case of an angled plug-in connector) is highly suitable. In the case of manufacture of a single-core electric cable 2, fitting in accordance with FIG. 3, whereby a line seal 29, followed by a cable retainer 30, followed by a retaining cap 31, are pushed onto the cable sheath 18 starting from the front end of the cable 2, may preferably be highly suitable.

In the context of the invention, various items of information may advantageously be recorded in the documentation 13 of the processing of the cable 2. For example, information from a check for an absence of damage to a cable component of the cable 2 (for example to the cable sheath 18, to the cable shielding braid 19 or to the insulation 22) may be taken into consideration. Furthermore, a check for an absence of damage to a plug-in connector component of the plug-in connector 24 to be fitted on the cable 2 may be performed, wherein the results of the check are ultimately recorded in the documentation 13. A check of a radial alignment of plug-in connector components may also be performed, the results of which are in turn recorded in the documentation 13. In particular, the result of a check for the presence of certain plug-in connector components after the fitting of the cable sheath 18, for example of the line seal 29, may also be advantageous in the context of the documentation 13.

FIG. 4 once again illustrates the multicore or two-core cable 2. By way of example, an inner conductor contact element 23 crimped to the first cable end 6 is shown for the upper inner conductor 17 of said first cable end. In respect of a crimping process, provision may be made, inter alia, to record information relating to the pressing power used during the crimping process in the documentation 13. In this respect, it is particularly advantageous to carry out all of the necessary crimping processes individually in order to document the respective individual pressing power.

In principle, any desired process parameters of the processing processes may be recorded in the documentation 13.

Furthermore, in the course of the manufacture of an electric cable 2, there is sometimes a need for defined axial positions of plug-in connector components relative to further plug-in connector components or relative to certain cable sections within specified tolerances. In particular in the context of quality management, provision may therefore be made for information relating to a check of an axial position of at least one plug-in connector component to be recorded in the documentation 13. For example, at least one of the axial distances A₁₋₅, illustrated in FIG. 4, between the front end of the cable 2 and the respective associated cable positions (exit point of the inner conductors 17 out of the filler layer 20/exit point of the filler layer 20 and/or the cable shielding braid 19 out of the cable sheath 18/front position of the fabric tape 25/rear position of the fabric tape 25/total length or manufacturing length of the cable 2) may be detected by measurement, for example by means of an optical sensor device 39, to be described herein, and documented in the context of the documentation 13.

Furthermore, the documentation of the results of a check of a diameter D of a cable section of the cable 2 may be provided, for example of the diameter D of the cable section at which the fabric tape 25 is provided, in order to ensure that a supporting sleeve can subsequently be pushed onto the fabric tape 25 in a further processing process.

Furthermore, information relating to the result of a check for protruding individual wires 32 (a protruding individual wire 32 of the cable shielding braid 19 is illustrated in each of FIGS. 4 and 6 by way of example) may be recorded in the documentation 13.

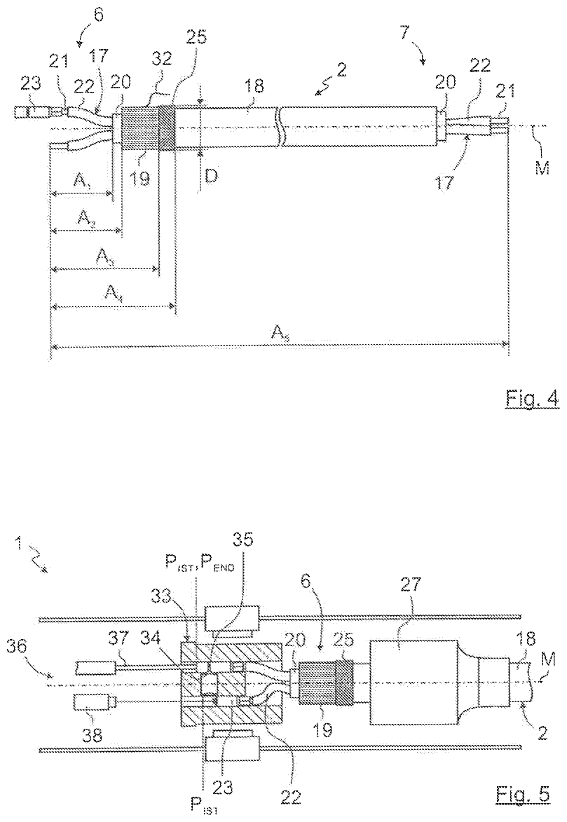

Documentation of a check for sufficient fastening, for example latching, of a plug-in connector component, for example of a contact parts carrier 33 receiving the inner conductor contact elements 23, may also be provided. FIG. 5 shows, by way of example, a processing process in the course of the manufacture of the multicore electric cable 2, according to which an actual axial position P_{IST} of at least one inner conductor contact element 23 fastened to the inner conductor 17 of the electric cable 2 within the contact parts carrier 33 relative to an intended axial end position P_{END} is checked. The inner conductor contact elements 23 have already been inserted into the contact parts carrier 33 at this time. By way of example, the inner conductor contact element 23 illustrated at the top in FIG. 5 is illustrated in its end position P_{END} and the inner conductor contact element 23 illustrated at the bottom in FIG. 5 has not yet been pushed into the receptacle of the contact parts carrier 33 to a sufficient extent.

In the exemplary embodiment, the axial end position P_{END} corresponds to the position of the front, free end of the inner conductor contact element 23 if the inner conductor contact element 23 is fully latched to a primary latching means 34.

In the case of the inner conductor contact element 23 situated in its axial end position P_{END}, the primary latching means 34, which is indicated purely by way of example, of the contact parts carrier 33 is latched to a complementary groove 35 of the inner conductor contact element 23. In principle, any desired latching connection between the primary latching means 34 and the inner conductor contact elements 23 may be provided.

In the context of the invention, a sensor unit 36 is provided, which is designed to detect the actual axial position P_{IST} of the at least one inner conductor contact element 23 within the contact parts carrier 33 relative to the intended axial end position P_{END}. FIG. 5 illustrates various sensors of the sensor unit 36 in combination by way of example.

For example, provision may be made for the sensor unit 36 to be designed to detect the position of a front, free end of the at least one inner conductor contact element 23 within the contact parts carrier 33.

The sensor unit 36 may have, for example, a tactile sensor, preferably a measuring probe 37 or a force transducer, which is insertable through the front opening or through a receptacle of the contact parts carrier 33. The illustration shows, by way of example, a measuring probe 37 for detecting the actual position P_{IST} of a front end face of the upper inner conductor contact element 23. Instead of the measuring probe 37, it is however similarly also possible for a force transducer to be provided in order to check the actual position P_{IST} by way a compressive or tensile check, in particular in order to determine whether the at least one inner conductor contact element 23 has been latched by the primary latching means 34. In this way, although it is generally not possible to detect the exact relative position of the inner conductor contact element 23, it is possible to determine whether the actual position P_{IST} corresponds to the intended axial end position P_{END}.

For contactless detection of the actual position P_{IST} of the inner conductor contact element 23 within the contact parts carrier 33, an optical sensor may also be provided for example. A laser system 38 for distance measurement is illustrated by way of example in FIG. 5. However, even a camera unit may be sufficient. Furthermore, contactless detection of the actual position P_{IST} is also possible, for example, by an inductive sensor or by a capacitive sensor which preferably detects the actual position P_{IST} of the inner conductor contact element 23 preferably through the contact parts carrier 33.

In as much as the sensor unit 36 has detected correspondence of the actual position P_{IST} with the intended end position P_{END}, provision may be made to continue the manufacturing process and to this end to note, for example, a successful processing process in the context of the documentation 13. As an alternative, a repair or a rejection of the electric cable 2 may be provided, and this may be determined subsequently, for example by a following processing module, owing to a documented incorrect or failed processing process in the context of the documentation 13.

In the context of the invention, provision may also be made for information relating to a check of electrical properties of the partially fitted or fully fitted plug-In connector 24 to be recorded in the documentation 13.

Information relating to waste and/or particle monitoring may also be used in order to be able to establish processing success of a processing module indirectly by comparing the waste produced in the course of the processing process or the particles produced with an expected quantity of waste or particles and/or an expected type of waste or particles.

As mentioned herein, provision may be made for the information for the documentation 13 to be detected by the control unit 16 using a communication interface or communication connection to a respective processing module. However, in the context of the invention, for the documentation 13, provision may also be made for the control unit 16 to detect the information for the documentation 13 by means of an independent sensor device 39.

By way of example, FIG. 6 illustrates an optical sensor device 39 in order to detect information for the documentation 13 in the context of optical quality monitoring of the cable 2.

Here, it is provided that the line of sight S of a first sensor 40 is aligned with the cable end 6, 7, wherein a first lighting unit 41 is arranged behind the cable end 6, 7 along the line of sight S of the first sensor 40 in order to generate transmitted light or back light for the optical detection of the cable end 6, 7. Furthermore, the line of sight S of a second sensor 42 is likewise aligned with the cable end 6, 7, wherein a second lighting unit 43 is arranged in front of the cable end 6, 7 along the line of sight S of the second sensor 42 in order to generate incident light for the optical detection of the cable end 6, 7. The first sensor 40 and the second sensor 42 are each formed as a camera 44 with a respective lens 45.

The second sensor 42 is arranged so as to be offset with respect to the first sensor 40 by a defined angle α. In principle, the angle α may be any angle, however an offset by an angle α of approximately 90° is particularly suitable.

Provision may be made for the sensors 40, 42 to be rotated radially around the central axis M of the cable 2 and/or for the cable 2 to be rotated around the central axis M while the sensors 40, 42 detect individual images or video information. In this way, the cable 2 may be optically detected all the way around. The respective lighting units 41, 43 are preferably rotated synchronously with their respectively associated sensors 40, 42.

The optical quality monitoring may comprise, for example, a check for stranded wires or individual wires 32 protruding from the cable end 6, 7. A check of the axial position of a plug-in connector component of a plug-in connector 24 to be fitted to the cable end 6, 7 and/or a check of a diameter D of a cable section adjoining the cable end 6, 7 may also be provided.

In order to ensure quality monitoring of the highest possible quality, provision may be made to carry out the state of the cable end 6, 7 at least after a cleaning process for removing particles adhering to the cable end 6, 7.

The information collected in this way may advantageously be used for the documentation 13 according to the invention.

FIG. 7 shows a system 26 for producing the electric cable 2. The system 26 comprises the device 1 for documenting the production of the electric cable 2, for example using the optical sensor device 39 described.

The system 26 further comprises at least two mutually independent processing modules for producing the electric cable 2. In principle, the system 26 may be suitable for producing a multicore cable 2 and/or a single-core cable 2. The production of a multicore cable 2 is specified merely by way of example.

In principle, the independent processing modules may be any desired modules for producing electric cables 2; FIG. 7 illustrates only a few exemplary processing modules. The order of processing or the arrangement of the processing modules may optionally also differ. Furthermore, further processing modules may be added or existing processing modules may be split up or combined.

The system 26 initially shows, by way of example, a first processing module 46 for aligning the electric cable 2 with the cable carrier 4 for subsequent processing.

For example, a processing module for stripping insulation from a portion of a cable component (for example the cable sheath 18) of the cable 2 may be arranged downstream of the first processing module 46. Furthermore, for example, a processing module for processing the cable shielding braid 19 and for applying the fabric tape 25 may be provided.

FIG. 7 illustrates, by way of example, a second processing module 47 for crimping the inner conductor contact elements 23 onto the inner conductors 17 of the cable 2. The pressing force used for this purpose may be documented in the context of the invention. For example, a cleaning module may be provided downstream of the second processing module 47 in order to clean the cable 2 to remove particles adhering to the cable 2.

By way of example, the device 1 according to the invention for documenting the production of the electric cable 2 is likewise arranged downstream of the second processing module 47 (and preferably a cleaning module). For example, the optical sensor device 39 described may be used in order to carry out a check for protruding individual wires 32, a check of an axial position of plug-in connector components 27, 28, 29, 30, 31 and/or a check of the diameter D of the fabric tape 25.

Further processing modules may be arranged downstream of the device 1 according to the invention, for example an illustrated third processing module 48 for fitting the contact parts carrier 33 on the inner conductor contact element 23 and for fixing the contact parts carrier 33 with an intended alignment or orientation using a shielding sleeve 27.

Any desired further processing modules may follow the third processing module 48, for example in order to fit further plug-in connector components or housing components in order to ultimately fully attach the desired plug-in connector 24 to the cable 2.

### Operation

Having described the structure of our Method, Device and System for Producing an Electric Cable, its operation is briefly described.

A principal object of the present invention is a method for producing an electric cable (2) comprising the steps: providing plural mutually independent processing modules (46, 47, 48) for processing the electric cable (2), and then plural mutually independent processing modules (46, 47, 48) process the electric cable (2) in succession; providing an information carrier (9, 10) that is assigned to a sheath clamp (49) that is fastened to a cable sheath (18) of the electric cable (2), and/or assigned to a cable carrier (4) that is assigned to the electric cable (2) during processing of the electric cable (2); and wherein documentation (13) of the processing of the electric cable (2) is compiled for at least one processing process of one of the plural mutually independent processing module (46, 47, 48), and the documentation (13) is assigned to the electric cable (2).

A further object of the present invention is a method for producing an electric cable (2) and further comprising: a unique identifier (14) for the electric cable (2), and the unique identifier (14) is stored on, and/or saved on, and/or imprinted on, and/or imprinted into the information carrier (9, 10).

A further object of the present invention is a method for producing an electric cable (2) and wherein the unique identifier (14) which is stored on, and/or saved on, and/or imprinted on, and/or imprinted into the information carrier (9, 10) is only temporarily assigned to the electric cable (2) during producing the electric cable (2).

A further object of the present invention is a method for producing an electric cable (2) and wherein the documentation (13) is at least partially stored on, and/or saved on, and/or imprinted on, and/or imprinted into the information carrier (9, 10).

A further object of the present invention is a method for producing an electric cable (2) and further comprising: a global database (15) to store and/or save the documentation (13); and the documentation (13) compiled in the course of the electric cable (2) producing process is assigned to individual electric cables (2).

A further object of the present invention is a method for producing an electric cable (2) and wherein the electric cable (2), the sheath clamp (49) and/or the cable carrier (4) are/is made identifiable by applying and/or modifying the information carrier (9, 10).

A further object of the present invention is a method for producing an electric cable (2) and wherein the information carrier (9, 10) is of optical form.

A further object of the present invention is a method for producing an electric cable (2) and wherein the optical information carrier (9) is a barcode a numerical code a 2D code, a data matrix code, or a QR code.

A further object of the present invention is a method for producing an electric cable (2) and wherein the electronic form information carrier (10) comprises at least one programmable memory module, to identify the electric cable (2) and/or to document the processing of the electric cable (2).

A further object of the present invention is a method for producing an electric cable (2) and wherein the complied documentation (13) is used for quality management.

A further object of the present invention is a method for producing an electric tale (2) and wherein the electric cable (2) is sorted, or reprocessed, in a manner dependent on information contained in the compiled documentation (13).

A further object of the present invention is a method for producing an electric cable (2) and further comprising: a control unit (16); a communication interface and/or a sensor device (39) operatively communicating with the control unit (16); and information for the compiled documentation (13) is detected by a control unit (16) using the communication interface and/or the sensor device (39).

A further object of the present invention is a method for producing an electric cable (2) and further comprising: an optical sensor device (39), with at least one optical sensor (40, 42), and the optical sensor device (39) is used to detect information for the compiled documentation (13) in the context of optical quality monitoring of the electric cable (2).

A further object of the present invention is a method for producing an electric cable (2) and wherein the at least one optical sensor (40, 42) is rotated radially around a central axis (M) of the electric cable (2), while the at least one optical sensor (40, 42) detects the information.

A further object of the present invention is a device (1) for documenting the production of an electric cable (2) during processing of the electric cable (2), comprising: plural mutually independent processing modules (46, 47, 48) that process the electric cable (2); an information carrier (9, 10) assigned to a sheath clamp (49) fastened to a cable sheath (18) of the electric cable (2), and/or to a cable carrier (4) assigned to the electric cable (2) during processing of the electric cable (2), and wherein the information carrier is for identification purposes; and wherein documentation (13) of the processing of the electric cable (2) for at last one processing process of one of the plural mutually independent processing modules (46, 47, 48) is assigned to the electric cable (2) by means of the information carrier (9, 10).

A further object of the present invention is a method for producing an electric cable (2) an wherein the electric cable (2) Is rotated around a central axis (M) of the electric cable (2) while the at least one optical sensor (40, 42) detects the information.

A further object of the present invention is a method for producing an electric cable (2) and wherein the information carrier (9, 10) is of electronic form.

A still further object of the present invention is a method for producing an electric cable (2) comprises the steps: providing plural mutually independent processing modules (46, 47, 48) for processing the electric cable (2), and the plural mutually independent processing modules (46, 47, 48) process the electric cable (2) in succession; providing an information carrier (9, 10) that is assigned to the electric cable (2) during processing of the electric cable (2); and wherein documentation (13) of the processing of the electric cable (2) is compiled for at least one processing process of one of the plural mutually independent processing modules (46, 47, 48), and the documentation (13) is assigned to the electric cable (2); and wherein information relating to a successful processing process information relating to an incorrect processing process, information relating to a failed processing process and/or information related to at least one process parameter of the processing process is recorded in the compiled documentation (13).

An even still further object of the present invention is a device (1) for documenting the production of an electric cable (2) during processing of the electric cable (2), comprising: plural mutually independent processing modules (46, 47, 48) that process the electric cable (2); an information carrier (9, 10) assigned to the electric cable (2) during processing of the electric cable (2), and wherein the information carrier is for identification purposes; and wherein documentation (13) of the processing of the electric cable (2) for at least one processing process of one of the plural mutually independent processing modules (46, 47, 48) is assigned to the electric cable (2) by means of the information carrier (9, 10); and wherein the documentation (13) contains information relating to a successful processing process, information relating to an incorrect processing process, information relating to a failed processing process and/or information related to at least one process parameter of the processing process.

In compliance with the statute, the present invention has been described in language more or less specific, as to structural and methodical features. It is to be understood, however, that the invention is not limited to the specific features shown and describe since the means herein disclosed comprise preferred forms of putting the invention into effect. The invention is, therefore, claimed in any of its forms or modifications within the proper scope of the appended claims appropriately interpreted in accordance with the Doctrine of Equivalents.

1. A method for producing an electric cable comprising the steps:
providing plural mutually independent processing modules for processing the electric cable, and the plural mutually independent processing modules process the electric cable in succession;
providing an information carrier that is assigned to a sheath clamp that is fastened to a cable sheath of the electric cable, and/or assigned to a cable carrier that is assigned to the electric cable during processing of the electric cable; and wherein
documentation of the processing of the electric cable is compiled for at least one processing process of one of the plural mutually independent processing modules, and the documentation is assigned to the electric cable.

2. The method for producing an electric cable as claimed in claim 1 and further comprising:
a unique identifier for the electric cable, and the unique identifier is stored on the information carrier.

3. The method for producing an electric cable as claimed in claim 2 and wherein the unique identifier which is stored on the information carrier is only temporarily assigned to the electric cable during producing the electric cable.

4. The method for producing an electric cable as claimed in claim 1 and wherein the documentation is at least partially sored on the information carrier.

5. The method for producing an electric cable as claimed in claim 1 and further comprising:
a global database to store the documentation; and
the documentation compiled in the course of the electric cable producing process is assigned to individual electric cables.

6. The method for producing an electric cable as claimed in claim 1 and wherein the electric cable, the sheath clamp and/or the cable carrier are/is made identifiable by applying and/or modifying the information carrier.

7. The method for producing an electric cable as claimed in claim 1 and wherein the information carrier is of optical.

8. The method for producing an electric cable as claimed in claim 7, and wherein the optical information carrier is a barcode, a numerical code, a 2D code, a data matrix codes or a QR code.

9. The method for producing an electric cable as claimed in claim 22 and wherein the electronic form information carrier comprises at least one programmable memory module, to identify the electric cable and/or to document the processing of the electric cable.

10. The method for producing an electric cable as claimed in claim 1 and wherein the compiled documentation is used for quality management.

11. The method for producing an electric cable as claimed in claim 10 and wherein the electric cable is sorted, or reprocessed, in a manner dependent on information contained in the compiled documentation.

12. (canceled)

13. (canceled)

14. The method for producing an electric cable as claimed in claim 1 and further comprising:
a control unit;
a communication interface and/or a sensor device operatively communicating with the control unit; and
information for the compiled documentation is detected by a control unit using the communication interface and/or the sensor device.

15. The method for producing an electric cable as claimed in claim 14 and further comprising:
an optical sensor device, with at least one optical sensor, and the optical sensor device is used to detect information for the compiled documentation in the context of optical quality monitoring of the electric cable.

16. The method for producing an electric cable as claimed in claim 15 and wherein the at least one optical sensor is rotated radially around a central axis (M) of the electric cable, while the at least one optical sensor detects the information.

17. A device for documenting the production of an electric cable during processing of the electric cable, comprising:
plural mutually independent processing modules that process the electric cable;
an information carrier assigned to a sheath clamp fastened to a cable sheath of the electric cable, and/or to a cable carrier assigned to the electric cable during processing of the electric cable, and wherein the information carrier is for identification purposes; and wherein
documentation of the processing of the electric cable for at least one processing process of one of the plural mutually independent processing modules is assigned to the electric cable by means of the information carrier.

18. (canceled)

19. (canceled)

20. (canceled)

21. The method for producing an electric cable as claimed in claim 15 and wherein the electric cable is rotated around a central axis (M) of the electric cable while the at least one optical sensor detects the information.

22. The method for producing an electric cable as claimed in claim 1 and wherein the information carrier is of electronic form.

23. A method for producing an electric cable comprising the steps:
providing plural mutually independent processing modules for processing the electric cable, and the plural mutually independent processing modules process the electric cable in succession;
providing an information carrier that is assigned to the electric cable during processing of the electric cable; and wherein
documentation of the processing of the electric cable is compiled for at least one processing process of one of the plural mutually independent processing modules, and the documentation is assigned to the electric cable; and wherein
information relating to a successful processing process, information relating to an incorrect processing process, information relating to a failed processing process and/or information related to at least one process parameter of the processing process is recorded in the compiled documentation.

24. A device for documenting the production of an electric cable during processing of the electric cable, comprising:
plural mutually independent processing modules that process the electric cable;
an information carrier assigned to the electric cable during processing of the electric cable, and wherein the information carrier is for identification purposes; and wherein
documentation of the processing of the electric cable for at least one processing process of one of the plural mutually independent processing modules is assigned to the electric cable by means of the information carrier; and wherein
the documentation contains information relating to a successful processing process, information relating to an incorrect processing process, information relating to a failed processing process and/or information related to at least one process parameter of the processing process.
